(19) United States
(12) Patent Application Publication
(10) Pub. No.: US 2004/0070629 A1
(43) Pub. Date: Apr. 15, 2004

(54) Graphical user computer interface

(75) Inventor: Christian Sebastian Seifert, Treuen (DE)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HEWLETT-PACKARD DEVELOPMENT COMPANY, L.P.

(21) Appl. No.: 10/642,506

(22) Filed: Aug. 18, 2003

(30) Foreign Application Priority Data
Aug. 16, 2002 (GB) 0219122.9

(51) Int. Cl. G09G 5/00

(52) U.S. Cl. 345/810

(57) ABSTRACT

A graphical user computer interface enables a user to open at least one menu and to select an item of the menu by means of a pointing device. The said pointing device has a two-dimension actuator and a one-dimension actuator and controls a moveable pointer and a moveable menu item focus. The two-dimension actuator controls movements of the pointer, and the one-dimension actuator is activated when the menu is opened to control movement of the menu item focus within the menu.

### FIELD OF THE INVENTION

The present invention relates generally to graphical user computer interfaces and, for example, a graphical user computer interface, a computer, a computer program product and a method for enabling a user to open at least one menu and to select an item of the menu by means of a pointing device.

### BACKGROUND OF THE INVENTION

In recent years the performance of computer systems has increased impressively thanks to better CPU times, faster clock rates, increased working memory, etc. As a result of faster computer systems, the computer programs which are run on the computer systems are also becoming more and more complex with regard to the handling of these programs. This complexity is compounded by an appropriation of more functionalities. Regarding the development of word processing programs, for example, the complexity of functionalities has increased impressively. In the beginning, as word processing programs were introduced into the private sector, these programs were provided with basic functionalities, i.e. the possibility of adjusting only a few parameters compared to the adjustment possibilities offered by word processing programs nowadays. Previously, it had been more or less possible to change the text type, size of the type and basically to adjust the frame. Certainly, in the word processing programs of more recent years, the number of these adjustments possibilities and features increased gradually but, without doubt, they cannot approximate to those word processing programs which are in use nowadays.

With increasing functionalities, features and thus complexity of contemporary computer program products, it is becoming more and more complicated to undertake an adjustment and/or to select a feature. This complication requires a correspondingly greater time commitment. In recent years, it was possible to select an item of a menu by opening the corresponding menu. Nowadays, as there are so many more items, it is sometimes necessary to open a menu and then a sub-menu to find and select the desired item of the menu. Sometimes, even the sub-menus themselves lead to further sub-menus of their own. This explains why it takes more time to find and select a desired menu item.

A selection can be made by inputting a special combination of keys or by using an appropriate pointing device, e.g. a computer-mouse, a touch pad or a pointing stick. The following relates to a brief description of a computer mouse. A computer-mouse includes a ball and a roller inside the mouse. By moving the mouse, the ball raps against the rollers inside the mouse. One roller measures side-to-side motion and the other measures up-and-down motion. The rollers have encoder wheels with metal points which send electrical signals to a computer-mouse software installed in the computer to determine speed and pointer position. The mouse is best operated on a mouse pad (a rectangular piece of material which provides better traction than the desk top). By moving the computer-mouse to the right on the surface of the pad, the pointer also moves to the right on the screen. The mouse is usually attached to the computer by a fine cable, but wireless mouse units also exist.

The top of the mouse contains one or more buttons (usually three). After moving the mouse pointer on the screen, it is possible to select a menu item by pressing and releasing a computer-mouse button, a “click”. A selection of a menu item is also possible by pressing and releasing a mouse button twice, which is called “double-clicking”. This process is often used to start programs or to open a document. The main advantage of a mouse is that it is easy to use and with a little practice, it is easier and faster to select items, start programs, operate a browser, etc., than using a keyboard. Especially in graphical environments a computer mouse is more or less essential to enable users to provide simple “point and click” instructions to the computer. The main advantage of a mouse over a keyboard is simplicity. There are also some operations that are much easier to perform with a mouse than a keyboard, such as picking an item on a screen or choosing from a list of options. Often a document or a web page holds more information than can fit on one screen. Thus, scrolling is an easy way to navigate on the web page.

It is easy to scroll up and down and side to side by using also the horizontal or vertical on-screen scroll bars at the bottom and on the right hand side of the screen. To scroll using the on-screen scroll bars, the user has simply to position his pointer on a slider on the scroll bar, to hold a mouse button down and to track the slider up and/or down on the vertical scroll bar or side to side on the horizontal scroll bar. It is also possible to position the pointer over arrows at the top and the bottom of the vertical scroll bar (left and right sides of the horizontal scroll bar) to move one line at a time.

A much faster and more convenient way of scrolling a page that holds more information than can fit on one screen is by using a wheel mouse. This kind of computer-mouse holds a wheel which is located between the two buttons. This wheel is programmed to move the image on the screen and it is possible to customise its movements. The most common use of the wheel mouse is for scrolling up and down a web page or a text document. Recent wheel mice include wheels which are coupled to a switch, so that the user can conveniently use the wheel for scrolling and “clicking”, e.g. selecting or executing an item or a program.

The user can choose between three interfaces for connecting the mouse to the computer, depending on the computer system and other equipment in use. The user can plug the mouse into a serial port, e.g. COM1, COM2, etc. Another possibility is to choose a PS/2 mouse port, which is essentially a serial port but at a different I/O address and with a different IRQ. As USB ports become more and more common, a USB mouse can be connected to a USB port.

Since programs and applications are getting more and more complex, as mentioned above, more and more time is needed to find and select an item which is in a menu or a sub-menu. In order to select an item which is associated with the sub-menu, the user has to point with the pointer to a menu which is associated with the sub-item, then he has to move the pointer inside the menu to an item of the menu which is associated with the sub-menu. When this is done, the sub-menu opens. Subsequently, the user has to point the pointer inside the sub-menu and then to select the desired sub-item. The user has to complete even more steps, if he wants to select an item which is embedded in a further sub-menu. It is thus clear that the user is forced to move the computer mouse a great deal, which is associated with a loss of time.

### SUMMARY OF THE INVENTION

A first aspect of the invention is directed to a graphical user computer interface enabling a user to open at least one menu and to select an item of the menu by means of a pointing device. That pointing device comprises a two-dimension actuator and a one-dimension actuator and controls a moveable pointer and a moveable menu item focus. The two-dimension actuator controls movements of the pointer, and the one-dimension actuator is activated when the menu is opened to control movement of the menu item focus within the menu.

According to another aspect, a graphical user computer interface is provided which enables a user to open at least one menu and to select an item of the menu by means of a pointing device. The pointing device controlling a moveable pointer and a moveable menu item focus, wherein, after the menu has been opened, the pointer stays at the position it was in when the menu was opened, while the menu item focus is moveable within the menu by means of the pointing device without moving the pointer.

According to a another aspect, a computer comprising a display and a pointing device with a two-dimension actuator and a one-dimension actuator is provided. The computer is programmed such that is provides a graphical user interface enabling a user to open at least one menu in the display and to select an item of the menu by means of the pointing device. The pointing device controls a moveable pointer and a moveable menu item focus such that the two-dimension actuator controls movements of the pointer, and the one-dimension actuator is activated when the menu is opened to control movement of the menu item focus within the menu.

According to another aspect, a computer comprising a display and a pointing device is provided. The computer is programmed such that it provides a graphical user interface enabling a user to open at least one menu in the display and to select an item of the menu by means of the pointing device. The pointing device controls a moveable pointer and a moveable menu item focus such that, after the menu has been opened, the pointer stays at the position it was in when the menu was opened, while the menu item focus is moveable within the menu by means of the pointing device without moving the pointer.

According to another aspect, a computer program product including program code is provided, when executed on a computer system, for providing a graphical user interface. The program code is arranged to enable a user to open at least one menu and to select an item of the menu by means of a pointing device which comprises a two-dimension actuator and a one-dimension actuator and controls a moveable pointer and a moveable menu item focus. The program is arranged to enable the two-dimension actuator to control movements of the pointer, and to activate the one-dimension actuator when the menu is opened to control movement of the menu item focus within the menu.

According to another aspect, a computer program product including program code is provided, when executed on a computer system, for providing a graphical user interface. The program code is arranged to enable a user to open at least one menu and to select an item of the menu by means of a pointing device. The program code is arranged to enable the pointing device to control a moveable pointer and a moveable menu item focus. The program code is arranged, after the menu has been opened, to enable the pointer to stay at the position it was in when the menu was opened, while the menu item focus is moveable within the menu by means of the pointing device without moving the pointer.

According to another aspect, a method is provided of enabling a user of a graphical user computer interface to open at least one menu and to select an item of the menu by means of a pointing device. The pointing device has a two-dimension actuator and a one-dimension actuator and controls a moveable pointer and a moveable menu item focus. The method comprises controlling movements of the pointer with the two-dimension actuator, and activating the one-dimension actuator when the menu is opened to control movement of the menu item focus within the menu.

According to another aspect, a method is provided of enabling a user of a graphical user computer interface to open at least one menu and to select an item of the menu by means of a pointing device. It comprises controlling a moveable pointer and a moveable menu item focus by the pointing device, and, after having opened the menu, enabling the menu item focus to be moved within the menu by means of the pointing device without moving the pointer, while the pointer stays at the position it was in when the menu was opened.

Other features are inherent in the products and methods disclosed or will become apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which:

FIG. 1 illustrates a graphical user computer interface by showing a detail, a menu;

FIGS. 2a-2c illustrate another detail of a graphical user computer interface, a context menu;

FIGS. 3a-3c illustrate another embodiment of a context menu;

FIG. 4 is a state diagram relating to the graphical user interface;

FIG. 5 illustrates a computer system;

FIGS. 6a and 6b show a wheel mouse and a simple computer mouse;

FIG. 7 illustrates components of a simple computer mouse.

### DESCRIPTION OF THE PREFERRED EMBODIMENTS

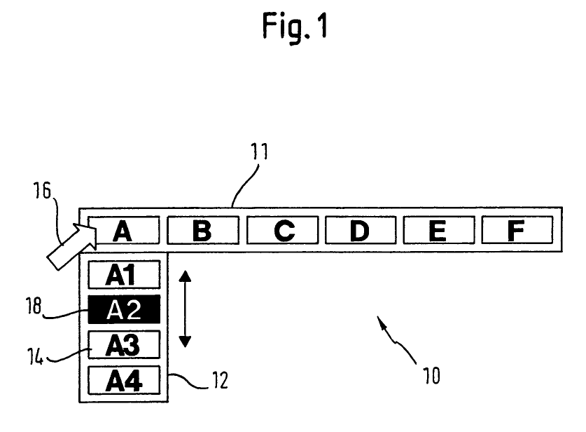

FIG. 1 illustrates an embodiment of a graphical user computer interface by showing a detail, a menu. This embodiment of the graphical user computer interface enables a user to open at least one menu displayed on a computer screen and to select an item of the menu by means of a pointing device which moves a pointer on a screen of a computer system.

Before proceeding further with the detailed description of the figures, a few items of the embodiments will be discussed.

In the embodiments the interface is a man-machine interface for proceeding a man-machine communication. This kind of interface differs from the kind of man-machine interface which serves to translate inputs from a user into a machine readable code, e.g. a keyboard. In a keyboard every input, i.e. push-button is static/determined and a user can input a fixed set of commands, determined by the keyboard. For example, using the “F1” button opens help-functions, using the “end” button moves the cursor to the end position of a row and, as a matter of course, using the letter buttons provides the computer system with text or information.

The graphical user computer interface of the embodiments is not a static interface as described above, but rather a dynamic one, the commands of which are not limited to a fixed set, as described above. This kind of interface rather offers the possibility to provide the computer system with “program individual inputs”. The inputs are provided by the user selecting graphical elements, instead of static buttons, as in the case of the keyboard. The interface of some of the embodiments is not to be understood as a “device”, but rather as a functionality provided by a computer program, when running on a computer or, alternatively, a computer which is programmed such that it provides the interface functionality. The visible part of the user interface is displayed on the computer screen. The described embodiments include on the one hand embodiments in which the pointing device only has a two-dimension actuator (e.g. a ball with rotation sensors for two different axes), and, on the other hand, embodiments with a two-dimension actuator and a one-dimension actuator (e.g. a wheel). In all embodiments, the pointing device may also have switching devices (e.g. buttons, wheel switches).

In the embodiments the menu is a graphical output, in particular a frame which includes graphical elements representing the menu items. After the menu has been opened (for example by positioning the pointer on a menu opening element and, optionally, clicking it), the menu is displayed and a menu item can be selected (for example by moving the focus onto the desired menu item), where upon the menu item is activated, e.g. a process associated with the menu item is started. In some of the embodiments, after the menu has been opened, the pointer stays at the position it was in when the menu was opened. In this situation, the menu item focus is moveable within the menu by means of the pointing device without moving the pointer. In some of these embodiments the menu item focus can be moved by moving the one-dimension actuator or, in alternative embodiments, by moving the two-dimension actuator. In some of the embodiments in which the pointing device is provided with a one-dimension actuator, that actuator is used for moving the menu item focus, instead of the two-dimension actuator.

In some of the embodiments, the menu item focus is a graphical output which accentuates at least one item of the menu. The accentuation can be performed by framing one item of the menu and/or pointing out said item by a highlight. Of course, other forms of accentuation are possible.

In the embodiments the menu is opened by positioning the pointer on a displayed element, associated with the menu. In some embodiments the opening is performed by clicking on the element, in other embodiments without clicking. The second alternative (without clicking on the element) can be provided with a time delay function which retards the opening of the menu for a period, such as one to three seconds.

In some of the embodiments, a menu item is activated by positioning the focus on it, with or without clicking on the menu item. In some embodiments the activating is performed by clicking the menu item (e.g. by pressing a mouse button or, if a wheel mouse is used, by actuating a switch integrated in the wheel mechanism), in other embodiments without clicking. In the second alternative embodiment (without clicking the menu item), the actual activation of the menu item can be retarded for a period, e.g. one to three seconds. In both alternatives, opening of the menu or activating of the menu item can be performed in other ways, such as by pushing a button on the keyboard, etc.

In some of the embodiments an operational shift from a pointer modus to a menu item focus modus is activated automatically upon opening of the menu. This operational shift causes the pointer to stay at the position it is in and causes the one-dimension actuator (in the embodiment with the one-dimension actuator) and the two-dimension actuator (in the embodiment with the two-dimension actuator) to control the one-dimensional movement of the menu item focus. However, in embodiments with a one-dimension actuator it is likewise possible that the pointer is not arrested, but remains movable under the control of the two-dimension actuator in the menu item focus modus. This menu item focus modus is held up as long until a shift back to the pointer modus occurs.

Normally, if a menu item has been activated and the associated process started, the opened menu will disappear and the menu item focus modus will automatically switch back to the pointer modus. However, the disclosed embodiments also enable the user to close the opened menu without activating a menu item focus. In one embodiment, the menu is closed by a relative movement of the menu item focus out of the menu. In other embodiments the menu is closed by selecting a special menu-closing item. This menu-closing item can be displayed within the menu, as the menu items, and can be selected by one-dimensional movement of the focus and activated, as the menu items. However, in embodiments with a one-dimensional actuator and a pointer movable in the menu item focus modus it is likewise possible to provide the menu-closing item at a position which is only reachable by the pointer (e.g. in a corner of the menu). Then, the menu is closed by moving the pointer under the control of the two-dimension actuator to the menu-closing item and, optionally, by clicking on it. The menu item focus modus shifts back to the pointer modus upon closing the menu. This shift enables the pointer to be moved again (if it was arrested).

There are different ways in which the movement of the menu item focus within the menu is performed. In some embodiments, the menu item focus is moveable while the menu is fixed on the screen. In other embodiments however the menu item focus is fixed on the screen while the menu is moveable. Furthermore, hybrids of the two forms are useful in the case of menus too large to be displayed at once, in which the focus is movable but the menu is scrolled when the focus is moved to the edge of the visible part of the menu. In all the above-mentioned cases, there is a relative movement between the menu item and the menu. All these kinds of relative movement can be realized in embodiments having only a two-dimension actuator as well as in embodiments having a two-dimension and a one-dimension actuator.

Returning now to FIGS. 1 and 5, a graphical user computer interface 10 is illustrated by showing a detail, a menu 12. This visible part of the graphical user computer interface is displayed on a computer screen 22 (FIG. 5) and comprises in this embodiment a menu bar 11 which includes six menus 12A to F, each menu “conceals” items 14 of the menu, respectively. The menu can be opened (and in this way the items of the menu are animated) by selecting the menu opening element which is associated with the menu. In the embodiment shown in FIG. 1 the menu A was opened by positioning the pointer 16 on the displayed element A, which is associated to the menu 12, with or without clicking on the element with the pointer 16, by means of a pointing device 30 (FIG. 5). In the same way, the other menus B to F can be opened, and thus the items of the corresponding menus can be animated. In this embodiment shown in FIG. 1, the menu 12 of the menu element A holds four items of the menu 14 (A1 to A4) which were animated after the user selected the menu element A with the pointer 16. After the menu 12 has been opened, the pointer 16 stays at the position it was in when the menu 12 was opened. Upon the opening of the menu 12, an operational shift from a pointer modus to a menu item focus modus is activated automatically. By opening the menu, a menu item focus 18 (seen here as highlighted text for item “A2”) accentuates one item of the menu 14. In an embodiment, the first upper item of the menu 14 will be accentuated by the menu item focus 18 upon opening the menu 12. However, the menu item focus 18 can be at other positions inside the menu 12 upon opening the menu. The user now has the possibility to move the menu item focus 18 to other positions. In the embodiment shown in FIG. 1 the user moved the menu item focus for example from position A1 to position A2. In an embodiment with a one-dimension actuator it is likewise possible that the pointer is not arrested, but remains movable under the control of the two-dimension actuator in the menu item focus modus. If the one-dimension actuator is a wheel, the user rotates the wheel, for example with his index finger, just one position downward, to move the menu item focus from position A1 to position A2. In another embodiment, which is particularly useful when the pointing device 30 is not provided with the one-dimension actuator, the menu item focus 18 is moveable within the menu 12 by means of the pointing device 30. In this case the user moves the menu item focus just by moving the simple computer mouse 34 in a downward direction, until the menu item focus is at position A2. In this embodiment, the pointer 16 stays at the position it was in when the menu was opened, as shown in FIG. 1. In another embodiment, the pointer 16 can be in another position, maybe at the centre of the screen or at other predefined positions.

In this embodiment of a graphical user computer interface 10, shown in FIG. 1, the user can move the menu item focus 18 to any other position inside the menu, as indicated by the double arrow. Now the user has the possibility to activate a desired menu item 14 by positioning the focus on it and clicking on the menu item. In another embodiment, the menu item can be activated by positioning the focus on it without clicking on the menu item. In this embodiment, after positioning the focus on a desired menu item, said menu item is activated after a delay of time, for example one to three seconds.

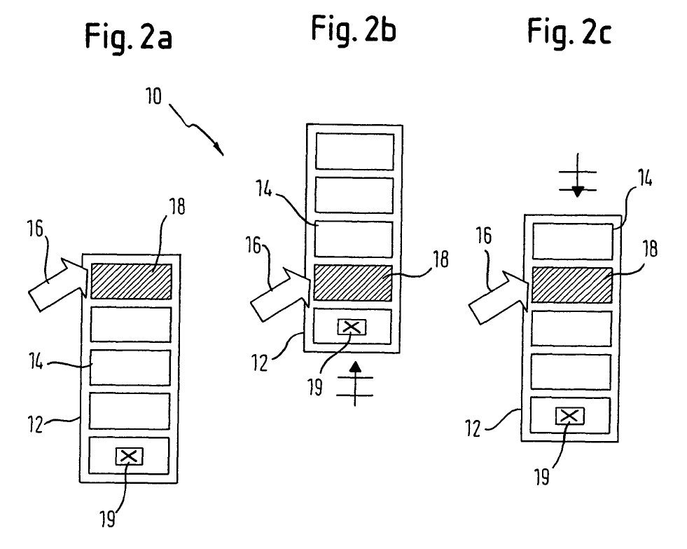

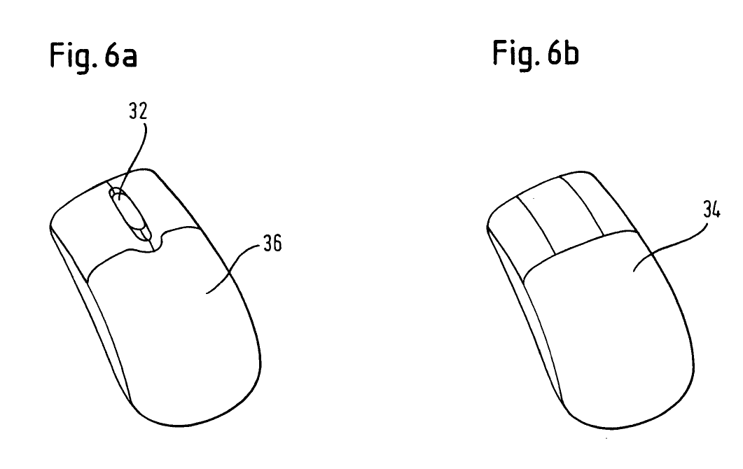

Normally, if a menu item has been activated and the associated process started, the opened menu will disappear and the menu item focus modus will automatically switch back to the pointer modus. Besides this there is another possibility which enables the user to close the opened menu without activating a menu item focus. In this case the user can close the menu by a relative movement of the menu item focus out of the menu. In an embodiment in which the pointing device is provided with the one-dimension actuator 32 (FIG. 6a), the user can move the menu item focus 14 out of the menu 12 by operating said one-dimension actuator, or by selecting a menu closing item 19 (FIG. 2), by using the one-dimension actuator or the two-dimension actuator. In another embodiment, in which the pointing device does not include the one-dimension actuator 32, this operation can only be executed by operating the two-dimension actuator. After closing the menu A, the operation modus shifts back from the menu item focus modus to the pointer modus and thus the user can move the pointer 16 as usual. Now the user can, for example, select another menu element, e.g. menu element B.

FIGS. 2a to 2c illustrate another detail of a graphical user computer interface 10, a context menu 12 which could have been opened for example by clicking a button of the pointing device 30. The context menu 12 could also be opened by other means, e.g. by means of the keyboard 26.

Most Windows programs, developed by Microsoft (Microsoft is a trademark of Microsoft Corporation) provide the possibility to open a context menu 12 which offers a “short-cut” selection of the most important features. For example, the word processing program WORD, developed by Microsoft offers the possibility to open a context menu 12 also includes the items “cut-off, copy, paste, etc.”, the context menu 12 also includes items for changing the letters, the paragraph between two adjacent rows and for inserting a numeration. The context menu 12 thus offers the possibility to make modifications in a short time.

As can be seen from the FIGS. 2a-c, the pointer 16 stays at the position it was in when the (context) menu 12 was opened, while the menu item focus 18 (here denoted by the darker menu item) is moveable within the menu 12 by means of the pointing device 30 without moving the pointer 16.

In an embodiment shown in FIG. 2a, upon opening the menu 12, the menu item focus 18 stays at the first upper position of the menu 12. Now, the menu 12 can be moved while the menu item focus 18 is fixed, which can be seen in FIGS. 2b-2c. Thereby, the relative position of the menu item focus 18 is changed inside the menu 12 and a desired item of the menu 14 can be selected by moving the menu 12 in an upward direction, as shown in FIG. 2b. FIG. 2c shows that it is of course possible to move the menu 12 in a downward direction again. This one-dimensional movement can be affected by operating the one-dimension actuator 32. Hence, the movement can also be achieved by moving the pointing device 30, i.e. the two-dimension actuator. In this case, after the context menu 12 has been opened, the pointer 16 stays at the position it was in when the menu 12 was opened, while the menu item focus 18 is moveable within the menu 12 by means of the pointing device 30 without moving the pointer 16.

After selecting the desired menu item 14 as described above, the menu item 14 is activated by positioning the focus on it, with or without clicking on the menu item 14. In some of the embodiments the user can close the context menu by a relative movement of the menu item focus out of the menu. In another embodiment the user can close the context menu by selecting the menu closing item 19, in comparison to the description of the embodiment shown in FIG. 1.

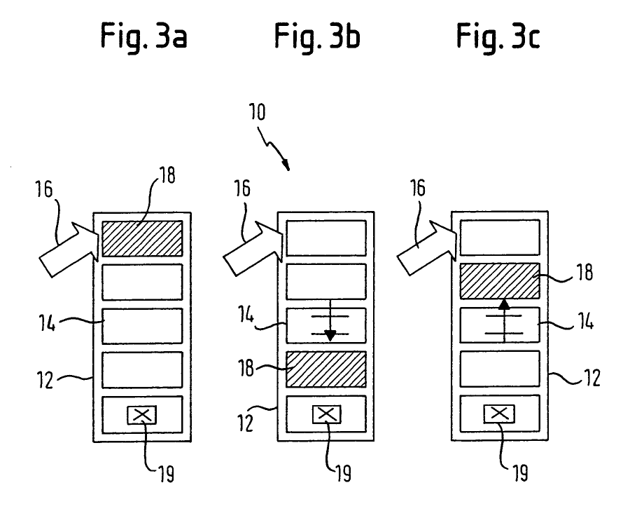

FIGS. 3a to 3c illustrate another embodiment of a context menu, wherein the menu item focus 18 is moveable while the menu 12 is fixed, upon operation of the one-dimension actuator 32 or by operating the pointing device 30. After the context menu 12 has been opened, the pointer 16 stays at the position is was in when the menu 12 was opened while the menu item focus 18 is moveable within the menu 12 by means of the pointing device 30 without moving the pointer 16. In FIG. 3b it is shown that the menu item focus 18 is moveable in a downward direction by operating the one-dimension actuator 32, as well as being movable in an upward direction. However, in another embodiment it is also possible to move the menu item focus 18 by moving the pointing device 30, i.e. the two-dimension actuator.

In the cases shown above the menu item is activated by positioning the focus on it, and clicking on the menu item. It is also possible that the menu item is activated by positioning the focus on it without clicking on the menu item. In this case, it is reasonable that a time delay of e.g. two or three seconds, is implemented, after which the menu item is activated.

In some of the embodiments an operational shift from a pointer modus to a menu item focus modus is activated automatically upon opening of the menu 12.

In another embodiment the menu 12 is closed by a relative movement of the menu item focus 18 out of the menu 12, by operating the one-dimension actuator 32, or by selecting the menu closing item 19 with the one-dimension actuator 32 or the two-dimension actuator. In the case that the pointing device 30 is not provided with the one-dimension actuator 32 it is unnecessary to mention that the operation mentioned above can only be executed by the two-dimension actuator. The context menus 12 shown in FIG. 3, as well as the context menus shown in FIG. 2, are provided with a menu closing item 19 at the lowest position. The menu closing item 19 can also be placed at other positions within the menu 12. This menu closing item can be displayed within the menu, as can the menu items, and can be selected by one-dimensional movement of the focus and activated in the same way as the menu items.

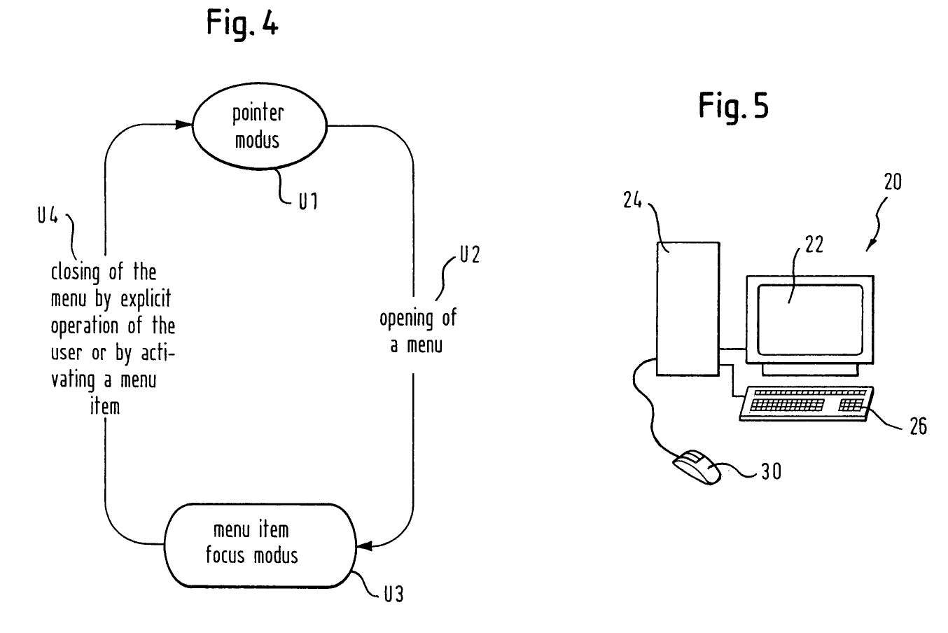

FIG. 4 is a state diagram for illustrating the operational shift from a pointer modus to a menu item focus modus and back. Generally, in state U1 the operation modus is in the pointer modus. In this state the pointer 16 can be used as known and follows the movement in accordance with the movement of the pointing device 30. At U2, by opening a menu 12, the operational modus shifts into state U3 to the menu item focus modus. In this state the pointer 16 stays at the position it was in when the menu 12 was opened. The pointer 16 can also stay at other positions displayed on the screen 22. In this state the menu item focus 18 is moveable within the menu 12 by means of the pointing device 30 without moving the pointer 16. In some of the embodiments the user can select an item of the menu 14 inside the menu 12 by means of the one-dimension actuator or the two-dimension actuator where the pointing device 30 is provided with a one-dimension actuator 32. In another embodiment the user can select the item of the menu solely by moving the two-dimension actuator, when the pointing device 30 is not provided with a one-dimension actuator 32 such as in the case of the simple computer mouse 34. When the menu is closed by an explicit operation of the user at U4, the operational modus shifts back to a pointer modus and reverts to the state U1. At U4 the user can close the menu in some of the embodiments if a menu item has been activated and the associated process started. Also by a relative movement of the menu item focus 18 out of the menu 12 by operating the one-dimension actuator 32 or by selecting a menu closing item 19 with the one-dimension actuator or the two-dimension actuator, the menu can be closed. At 4, the user can also close the menu by activating a menu item 14. In this case the user can activate the menu item by positioning the menu item focus 10 on it, with or without clicking on the menu item. When returned to state U1 (to the operational modus) the user can move the pointer 16 by moving the pointing device 30, as usual.

FIG. 5 illustrates a computer system 20. The computer system comprises a screen 22, a processing unit 24, a keyboard 26 and a pointing device 30. The detail of the graphical user computer interface 10 in an embodiment shown in FIG. 1, as well as the other details of graphical user interfaces of other embodiments illustrated in FIGS. 2 and 3, are displayed on the computer screen 42. The functionality of the graphical user computer interfaces 10 mentioned above is provided by a computer program, when running on the processing unit 24. Alternatively, the processing unit 24 is programmed such that it provides the interface functionality.

FIGS. 6a to 6b show embodiments of a pointing device 30. FIG. 6a shows an embodiment of a pointing device 30 with a one-dimension actuator 32, which is a wheel. This kind of pointing device is a so-called wheel mouse 36. The wheel combination simplifies the scrolling and searching of documents, which reduces the number of times a user has to move his hand from mouse to keyboard. Other embodiments of a one-dimension actuator 32 are possible.

FIG. 6b shows a simple computer mouse 34, which is the most common pointing device 30 used for computer systems 20, and almost as essential as a keyboard. Competitive devices such a track balls and touch sensitive pads (not shown) have flourished, but they are nowhere near as prevalent as the simple computer mouse.

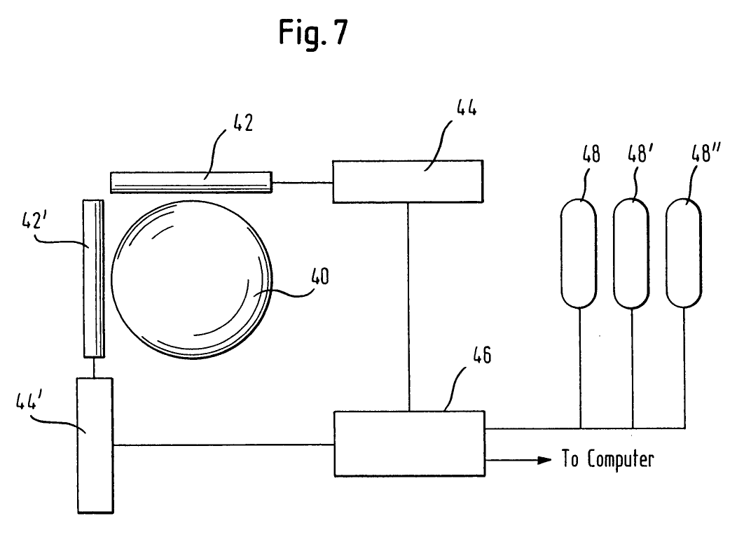

FIG. 7 illustrates components of a simple computer mouse 34. As shown in the figure the computer mouse contains two kinds of input electronics, one part of the computer mouse detects movement and reports it, the other part detects button activity and reports that. The movements of the computer mouse are converted into electrical signals and then transmitted to the computer system 20. The computer mouse shown in this figure uses a mechanical ball 40 for sensing the movement. This ball 40, when it rolls, causes two rollers 42, 42′ to turn. The rollers are mounted perpendicular to each other so that they each detect one of two directions. The movements of the rollers 42, 42′ are coupled into motion-digitizers 44, 44′ that sense rotation. These motion-digitizers 44, 44′ thus report that rotation to a processor interface 46, which creates and sends messages to the computer system. Also signals from buttons 48, 48′, 48″, provided on the top of the computer mouse 34, are transmitted to said processor interface 46.

All functionalities described above can be implemented in an operating system as well as in an application system environment, although it is more reasonable to implement the functionalities in the library of the operating system.

However the functionalities can be developed and distributed “from outside”, i.e. as additional parts to Windows (95/98/ME/NTB4/2000/XP), or as a window-manager for UNIX, from third parties. Another possibility is offered by JAVA as an independent operating system for implementing said functionalities. In this case, the framework, e.g. Swing-Classes, which is used for displaying the windows, must be adapted.

With the described embodiments, the user is not forced to move the mouse as far as with prior solutions. After the item of the menu 14 has been chosen the pointer is located in the same position as it was in before the menu was opened. This can be advantageous if context-sensitive menus are opened, for example. This is because after the item of the menu has been selected, the mouse pointer 16 still stays over the element for which the context menu was opened, providing the ability to proceed immediately with further commands. When using the computer mouse, the hand of the user is less moving because only the fingers have to be moved, not the whole hand, as when moving a conventional mouse. Thus, a general purpose of the embodiments is to provide an improved graphical user computer interface which is easy to handle and reduces a user's loss of time.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appending claims either literally or under the doctrine of equivalence.

What is claimed is:

1. A graphical user computer interface enabling a user to open at least one menu and to select an item of the menu by means of a pointing device, said pointing device comprises a two-dimension actuator and a one-dimension actuator and controls a moveable pointer and a moveable menu item focus,
wherein the interface is arranged such that the two-dimension actuator controls movements of the pointer, and
the one-dimension actuator is activated when the menu is opened to control movement of the menu item focus within the menu.

2. The graphical user computer interface of claim 1, arranged such that, after the menu has been opened, the pointer stays at the position it was in when the menu was opened, while the menu item focus is moveable within the menu by means of the pointing device without moving the pointer.

3. The graphical user computer interface of claim 1, arranged such that the menu is opened by positioning the pointer on a displayed element, associated with the menu, with or without clicking on the element.

4. The graphical user computer interface of claim 1, arranged such that the menu item is activated by positioning the focus on it, with or without clicking on the menu item.

5. The graphical user computer interface of claim 1, arranged such that an operational shift from a pointer modus to a menu item focus modus is activated automatically upon opening of the menu.

6. The graphical user computer interface of claim 1, arranged such that the menu item focus is movable while the menu is fixed or the menu item focus is fixed while the menu is movable, upon operation of the one-dimension actuator.

7. The graphical user computer interface of claim 1, arranged such that the menu is closed by a relative movement of the menu item focus out of the menu, by operating the one-dimension actuator, or by selecting a menu closing item with the one-dimension actuator or the two-dimension actuator.

8. The graphical user computer interface of claim 1, arranged such that an operation modus shifts from a menu item focus modus back to a pointer modus upon closing of the menu.

9. The graphical user computer interface of claim 1, wherein the one-dimension actuator is a wheel.

10. A graphical user computer interface enabling a user to open at least one menu and to select an item of the menu by means of a pointing device, said pointing device controlling a moveable pointer and a moveable menu item focus,
wherein the interface is arranged such that, after the menu has been opened, the pointer stays at the position it was in when the menu was opened, while the menu item focus is moveable within the menu by means of the pointing device without moving the pointer.

11. The graphical user computer interface of claim 10, arranged such that the menu is opened by positioning the pointer on a displayed element, associated with the menu, with or without clicking on the element.

12. The graphical user computer interface of claim 10, arranged such that the menu item is activated by positioning the focus on it, with or without clicking on the menu item.

13. The graphical user computer interface of claim 10, arranged such that an operational shift from a pointer modus to a menu item focus modus is activated automatically upon opening of the menu.

14. The graphical user computer interface of claim 10, arranged such that the menu item focus is movable while the menu is fixed or the menu item focus is fixed while the menu is movable, by operating the pointing device.

15. The graphical user computer interface of claim 10, arranged such that the menu is closed by a relative movement of the menu item focus out of the menu, by operating the two-dimension actuator, or by selecting a menu closing item with the two-dimension actuator.

16. The graphical user computer interface of claim 10, wherein the pointing device is a computer-mouse.

17. A computer comprising a display and a pointing device with a two-dimension actuator and a one-dimension actuator,
said computer is programmed such that it provides a graphical user interface enabling a user to open at least one menu in the display and to select an item of the menu by means of the pointing device, and
that the pointing device controls a moveable pointer and a moveable menu item focus such that
the two-dimension actuator controls movements of the pointer, and
the one-dimension actuator is activated when the menu is opened to control movement of the menu item focus within the menu.

18. A computer comprising a display and a pointing device,
said computer is programmed such that it provides a graphical user interface enabling a user to open at least one menu in the display and to select an item of the menu by means of the pointing device, and
that the pointing device controls a moveable pointer and a moveable menu item focus such that,
after the menu has been opened, the pointer stays at the position it was in when the menu was opened, while the menu item focus is moveable within the menu by means of the pointing device without moving the pointer.

19. A computer program product including program code, when executed on a computer system, for providing a graphical user interface, wherein the program code is arranged to enable a user to open at least one menu and to select an item of the menu by means of a pointing device which comprises a two-dimension actuator and a one-dimension actuator and controls a moveable pointer and a moveable menu item focus,
the program is arranged to enable the two-dimension actuator to control movements of the pointer, and
to activate the one-dimension actuator when the menu is opened to control movement of the menu item focus within the menu.

20. A computer program product including program code, when executed on a computer system, for providing a graphical user interface,
wherein the program code is arranged to enable a user to open at least one menu and to select an item of the menu by means of a pointing device,
wherein the program code is arranged to enable said pointing device to control a moveable pointer and a moveable menu item focus,
wherein the program code is arranged, after the menu has been opened, to enable the pointer to stay at the position it was in when the menu was opened, while the menu item focus is moveable within the menu by means of the pointing device without moving the pointer.

21. A method of enabling a user of a graphical user computer interface to open at least one menu and to select an item of the menu by means of a pointing device, said pointing device having a two-dimension actuator and a one-dimension actuator and controls a moveable pointer and a moveable menu item focus, comprising:
controlling movements of the pointer with the two-dimension actuator, and
activating the one-dimension actuator when the menu is opened to control movement of the menu item focus within the menu.

22. A method of enabling a user of a graphical user computer interface to open at least one menu and to select an item of the menu by means of a pointing device, comprising:
controlling a moveable pointer and a moveable menu item focus by the pointing device,
after having opened the menu, enabling the menu item focus to be moved within the menu by means of the pointing device without moving the pointer, while the pointer stays at the position it was in when the menu was opened.
